(19) United States
(12) Patent Application Publication
(10) Pub. No.: US 2025/0252521 A1
(43) Pub. Date: Aug. 7, 2025

(54) SYSTEM AND METHOD FOR IDENTIFYING A STALKING VEHICLE

(71) Applicant: Sean Boutros, Houston, TX (US)

(72) Inventor: Sean Boutros, Houston, TX (US)

(21) Appl. No.: 18/432,261

(22) Filed: Feb. 5, 2024

(51) Int. Cl. G06Q 50/26; G06V 10/75; G06V 10/774; G06V 10/778; G06V 20/54; G06V 20/58; G07C 5/00

(52) U.S. Cl. CPC G06Q 50/265; G06V 10/75; G06V 10/774; G06V 10/778; G06V 20/54; G06V 20/58; G07C 5/008; G06V 2201/08

(57) ABSTRACT

A method and system for identifying in real time if a vehicle is being followed or stalked such as to determine where the driver lives or even to rob or assault the driver once the destination has been reached. A computing device or processor in data communication with the vehicle display screen repeatedly receives image data in real time from a rear-facing imaging assembly is operable to capture images indicative of automobiles following closely behind the monitoring vehicle. The computing device is connected to the Internet so as to access various databases concerning automobile images, distinguishing parameters, traffic flow, metropolitan traffic surveillance systems, and the like. Image data taken by the rear-facing imaging assembly may be compared in real time using artificial intelligence and machine learning and over a period of time during travel and when reaching a destination so as to determine if the monitoring vehicle has been followed.

### BACKGROUND OF THE INVENTION

This invention relates to vehicle tracking systems and, more particularly, to a method for identifying in real time if a vehicle is being stalked or followed for malicious reasons.

There are significant dangers associated with a vehicle being followed to the residence of its owner for malevolent intentions, including assault, battery, robbery, and even murder. This issue is becoming increasingly common and poses a serious threat to personal safety and emphasizes the need for heightened awareness and precautionary measures.

Following a vehicle to its residence is a tactic commonly employed by criminals seeking to target individuals for various nefarious purposes. This tactic provides perpetrators with an opportunity to ambush victims in the relative seclusion and vulnerability of their own homes. Alternatively, this tactic enables a criminal to learn the patterns of a homeowner so as to know when they go to work and return home. This criminal mindset may lead to future burglaries of the home.

Following an individual to their residence increases the likelihood of a direct physical confrontation, potentially leading to injuries or even fatalities. Further, victims who experience this form of stalking often suffer from heightened anxiety, stress, and fear for their safety and that of their loved ones. Accordingly, there is now an increased need for individuals such as drivers of vehicles to be mindful of their surroundings and any suspicious behavior while driving home, such as the reality of being followed.

Therefore, it would be desirable to have a method and system for identifying in real time if a vehicle is being followed or stalked. Further, method for identifying if a vehicle is being followed that collects imaging data using an imaging device mounted in a rear window of a monitoring vehicle. Still further, it would be desirable to have a method for tracking follower vehicles that accesses a vehicle ID database for comparison with collected imaging data and that uses machine learning and artificial intelligence to identify vehicles that may be stocking the monitoring vehicle. In addition, it would be desirable to have a method for identifying if a vehicle is being stalked that utilizes traffic network camera systems, traffic mapping systems, and utilizes vehicle turning instrumentation.

### SUMMARY OF THE INVENTION

According to the present invention, a method and system is disclosed for identifying in real time if a vehicle is being followed for nefarious purposes, i.e., determining if a vehicle is being stalked so as to determine where the driver lives or even to rob or assault the driver once the destination has been reached. According to the invention, a computing device, such as a computer or processor in data communication with the vehicle or auxiliary display screen, repeatedly receives image data in real time from a rear-facing imaging assembly (such as a camera or video camera) operable to capture images indicative of automobiles following closely behind the monitoring vehicle. Preferably, the computing device is connected to the Internet so as to access various databases concerning automobile images, distinguishing parameters, traffic flow, metropolitan traffic surveillance systems, and the like. Accordingly, image data taken by the rear-facing imaging assembly may be compared in real time and over a period of time during travel and especially when reaching a destination so as to determine if the monitoring vehicle has been followed.

In one aspect, the computing device may be connected to an online database that includes a plurality of images of automobiles along with a plurality of defining features and the computing device may be programmed to identify and document a plurality of vehicles following the monitoring vehicle in real time. This exercise may be repeated at short intervals and, through a series of comparisons, a subset of following vehicles may be indicated. In other words, if a subset of vehicles is identified in a closely following position, the computing device may alert either audibly or visually of the potentially stalking vehicle(s).

In another aspect, the computing device may be connected to a traffic surveillance system such as one that includes still or video feeds showing traffic flow at predetermined locations in real time. Accordingly, the computing device is operable to synchronize photographs or video of the monitoring vehicle along with respective vehicles following closely behind. Again, the trailing vehicles can be positively identified and then repeatedly compared over time to determine the presence of a potential or definite stalking vehicle.

In still another aspect, the computing device may be connected to a traffic flow system such as one that enables a user to enter a starting destination and an ending destination and then to choose from multiple possible routes therebetween. The computing device, in communication with the traffic flow system, may be configured to determine a likelihood of two or more vehicles selecting the exact same route in order to reach the predetermined destination. Especially if the monitoring vehicle is traveling from a place of employment to his residence in a metropolitan area, the chances of two or more vehicles choosing the exact same route is statistically remote; therefore, this statistic yields strong corroboration if the methods described above alert to a “potentially stalking vehicle.” In other words, if the prior methods predict a “potential stalking alert” and the chances of two vehicles choosing the same route is less than 1% likely, then a positive alert of a stalking vehicle is corroborated and the alert is published, such as audibly and visually.

In yet another aspect, the system may include an accelerometer mounted in the monitoring vehicle and that is configured to detect when a turn is made. Accordingly, imaging data may be received immediately before a turn and immediately after a turn and then compared to determine if the same vehicle(s) made the same turn and is, therefore, still following. These comparisons can be made repeatedly and, most definitely, upon arrival at the predetermined destination to determine if the same following vehicle also made the same turns.

In a critical aspect, the computing device may include algorithms using machine learning and artificial intelligence to more accurately identify following vehicles by rapidly processing thousands of training examples and then to predict a likelihood that identified automobiles are, in fact, following the monitoring vehicle.

Therefore, a general object of this invention is to provide a method and system for identifying in real time if a vehicle is being stalked

Another object of this invention is to provide a method and system, as aforesaid, that uses mobile Internet connections to access an automobile identifying database, a traffic flow surveillance system, and a travel mapping system for correlating identified automobiles in real time that are observed as following the monitoring vehicle.

Still another object of this invention is to provide a method and system, as aforesaid, that includes an accelerometer in communication with the computing device and configured to determine when the monitoring vehicle has turned a corner, the computing device being configured to receive image data that before and after the turn and compare it to determine if a same following vehicle also executed the same turn, i.e., is still following the monitoring vehicle.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a schematic view illustrating a monitoring vehicle in an initial configuration ready to run software indicative of a preferred embodiment of the present invention;

FIG. 1b is a schematic view of the present invention as in FIG. 1a, illustrated in a configuration prompting a user to selectively access traffic resources via the Internet for implementing methodologies corresponding to the present invention;

FIG. 1c is another schematic view of the present invention as in FIG. 1a, illustrated in a configuration prompting a user to selectively access other traffic resources via the Internet according to the present invention;

FIG. 1d is another schematic view of the present invention as in FIG. 1a, illustrated in a configuration providing an audible and visual alert to a driver indicating the presence of a stalking vehicle being detected;

FIG. 2 is a block diagram illustrating the traffic control systems accessed via the Internet according to the present invention;

FIG. 3a is a block diagram according to the present invention, illustrating the electronic components of the computing device;

FIG. 3b is a block diagram illustrating the electronic communications between the computing device and the imaging device according to the present invention;

FIG. 4 is a flowchart illustrating the steps of process 100 according to the present invention; and

FIG. 5 is a block diagram illustrating a vehicle identification system to which imaging data collected according to the present invention may be compared.

### DESCRIPTION OF THE PREFERRED EMBODIMENT

A method for identifying in real time if a vehicle is being followed or stalked according to a preferred embodiment of the present invention will now be described with reference to the accompanying drawings. The method 100 and system 10 includes a computing device 20 and an imaging assembly 30 mounted in a vehicle 12 (also referred to as a monitoring vehicle), the computing device 20 being capable of electronic and data connections to systems and databases via the Internet 11.

The system 10 for determining a likelihood that a monitoring vehicle 12 is being followed or even stalked for nefarious reasons includes a computing device 20 such as a laptop computer, a tablet, or a smart phone and that may be connected to a wide area network. As is becoming well known, a moving automobile is just as capable of connecting to the Internet 11 as is a computer connecting to the Internet using a home router. More particularly, a car has a transmitter and receiver similar to that of a router and connects to the Internet using a cellular network (like a cell phone). In addition, there are other electronic devices for creating a so-called “hot-spot” apart from the electronics of an automobile. Further, the computing device 20 may include a non-transitory storage medium, i.e., a memory 21, and a processor 22 capable of executing programming code 21a (or just referred to as programming) stored in said memory 21. As will be described in greater detail later, the programming stored in said memory 21 may include instructions that, when executed by the processor 22, facilitate connection to specified websites such as the automobile identification database 40, a traffic surveillance system 50, a travel mapping system 60, and the like. The programming code 21a may also include instructions for comparing image data with automobile identification data and for drawing conclusions regarding a likelihood or prediction of future actions. To that end, the programming code may include algorithms that utilize machine learning and artificial intelligence paradigms 21c that are trained using thousands of examples, automobile images, automobile component specifications, and other distinguishing factors as will be described in greater detail later. In other words, artificial intelligence paradigms may be strategically included for utilizing many thousands of data points in ways that would not be feasible either immediately or with a general-purpose computing system. Stated another way, the present invention is accomplished by accessing multiple systems, specifically trained artificial intelligence algorithms, and combinations thereof so as to determine and corroborate a likelihood that a monitoring vehicle is being followed or stalked in real time such that a driver can be even more cautious upon arriving at a destination or even call for law enforcement personnel. This analysis is specifically based on data from multiple sources correlated with real-time data and is something more than general computing.

In addition, the memory 21 includes data structures 21b, i.e., memory locations, configured for storing data, such as data generated as a result of the image data, comparison data, matching data, and the like as will be described below in more detail.

Preferably, the computing device 20 is in data communication with a display module 14 (also referred to merely as a display 14) within the interior of the monitoring vehicle 12. In an embodiment, the display 14 may include a graphic user interface (GUI) and a touch screen interface 14a such that the display 14 is configured to receive input data from an operator inside the vehicle 12. In addition, alert notices, such as an alert indicative of the presence of a stalking vehicle may also be published visually on the display 14 or audibly via a speaker 15.

In a critical aspect, the system 10 may include an image assembly 30 configured for acquiring or receiving data indicative of objects in proximity thereto. More particularly, the image assembly 30 (which may also be referred to as an imaging device) may include a camera, a video camera, a license plate reader, or the like. In an embodiment, the image assembly 30 may be mounted in a rear-facing orientation in the interior of the monitoring vehicle 12, such as proximate a rear windshield so as to have a clear path for taking photographs or video footage of automobiles following the monitoring vehicle 12. It is understood that the imaging device (i.e., the camera) may also referred to as an imaging sensor (also referred to simply as a sensor) and is capable of generating image data when actuated. In an embodiment, the imaging assembly 30 may be actuated by the computing device 20 to repeatedly collect image data 31a in real time and to make this collected image data 31a available to the computing device 20. Stated another way, the imaging assembly 30 may be energized to stream real-time images to the computing device 20 where they may be compared to automobile images located on an automobile identification database 40. More particularly, the computing device 20, under program control, may access the automobile identification database 40 via the Internet 11 and submit images collected/captured by the imaging assembly 30 for comparison and identification. It is understood that the imaging assembly 30 may be capable of—either individually or in cooperation with program code being executed by the computing device 20—to represent following automobiles numerically, such as using pixel and pixel combinations indicative of color data, shape data, grill pattern data, bumper data, headlight data, windshields data, and the like. It is with this input data that the automobile identification database 40 may be configured to identify a make and model and color that matches the submitted pixel inputs. Accordingly, the computing device is operable to then generate identifying data indicative of all automobiles that exhibit the identified characteristics. As will be described below, the identified following automobiles may be compared by the computing device 20 over a period of time to determine if there is a single automobile or combination of vehicles that are identified repeatedly and, especially, once the destination has been reached.

For instance, the computing device 20 is operable to compare the generated identifying data collected and identified over a period of consecutive real time intervals so as to determine if a single identified vehicle has been identified repeatedly and, if so, said identified vehicle may be labeled as a potential stalking vehicle. In an embodiment, image data associated with a final interval of time (i.e., when a predetermined destination has been reached, such as when the driver has reached his residence) may be compared to a predetermined number of previous comparisons to determine if a common following vehicle can be identified and, if so, the common following vehicle may be labeled as a confirmed following vehicle and an alert may be published on the display 14 or via a speaker 15. In an embodiment, predetermined emergency phone numbers or security services may be called if there is an alert. As will be described later, the prediction described above may be corroborated using other data points.

In a critical aspect, the computing device 20, when executing programming related to the step of comparing the collected identifying data to data from the automobile database, is operable to use algorithms that utilize the paradigms known as machine learning (ML) and artificial intelligence (AI) to determine and generate the identifying data points. Accuracy capable of being trusted to make predictions are a result of the ML/AI algorithms 21c being trained using thousands of automobile images and pixel values associated with respective automobile components. It is understood that the training of ML/AI algorithms goes far beyond the capabilities of a general-purpose computer or manual capability.

To be thorough in the disclosure, the concept of machine learning and artificial intelligence will be described in greater detail.

In the last decade, the applications of machine learning (ML) algorithms have proliferated in many areas of scientific, industrial, and medical applications. In general, modern artificial intelligence (AI) systems are capable of classifying very complex data with high precision. The term artificial intelligence (AI) is an umbrella term covering many different categories of specific techniques, including machine learning (ML), natural language (NL), and neural networks. The algorithms have inspired the development of novel artificial neural networks (ANN or NN) forming the basis of the field of artificial intelligence (AI). The developments have been in response to the vast amount of data, known as Big Data, which require new approaches to their processing, storage, and information extraction. Not without some limitations, AI continues to find new applications and provide fast information extraction based on algorithm embedded knowledge acquired with the use of available data in order to process newly available data: the process also known as NN training.

In another critical aspect, the computing device, executing respective programming, is capable of accessing a traffic surveillance system 50 (also referred to as a traffic surveillance system) in real-time via the Internet 11. Traffic surveillance systems are increasingly used by large and medium sized cities and have multiple benefits, including improved traffic flow, enhanced data gathering, traffic crime reduction, safer roadways and construction zones, and the like. For instance, sophisticated traffic surveillance systems may be able to detect traffic buildup and issue alerts to drivers, the presence of cameras influences drivers to obey traffic laws, and openly dumping trash along surveilled roadways is reduced. Further, some municipalities are placing cameras in business districts or even residential areas in hopes of documenting criminal activity or stopping criminal behavior before it ever happens. Indeed, when a high profile murder or abduction occurs, one of the first and most powerful investigative tools is for law enforcement to obtain and review all available video footage from municipal surveillance systems as well as from private company surveillance footage and even residential camera data.

In the present invention, a snapshot or video clip taken by a surveillance camera at a corresponding vehicle location and at a precise moment in time is a valuable means for identifying what cars may be following the monitoring vehicle 12. The computing device 20 may be configured to obtain this captured image data from the accessed traffic surveillance system 50. Further, the computing device 20 may be configured, such as via its programming, to compare the captured image data from the surveillance system with the data from the vehicle identification system so as to determine more exacting information as to the identity of the follower vehicles. Also as described above, this identification in comparison may be made repeatedly over multiple and consecutive time intervals and compared to determine if a single automobile or plurality of automobiles are shown to be following the monitoring vehicle. Also similar to the method described above, the computing device 20 may be configured to use algorithms utilizing machine learning (ML) and artificial intelligence (AI) to determine generated identifying data regarding automobile identities. Again, the ML/AI algorithms may be trained using thousands of automobile images and a multitude of specific automobile characteristics that may be mathematically expressed or associated with pixel values. The details of this process will be discussed again with reference to process 100 shown in FIG. 4.

In a related embodiment, the monitored vehicle 12 may simply generate GPS or address codes and associated real-time data and may correlate the collected address and time data to surveillance camera locations and obtain traffic surveillance data on or about the collected location and time. As discussed above, the collected data provides actual camera or video footage of traffic immediately following the monitored vehicle 12 and using the AI/ML techniques described above, may determine if the monitored vehicle 12 is likely being followed.

In another critical aspect, the computing device 20, executing respective programming, is capable of accessing a traffic mapping system 60 in real-time and via the Internet 11. A travel mapping system/application 60 is computer software that enables a traveler to obtain one or more maps of a route between point A and point B along with information about expected time of travel, possible construction zones, and other travel information. The user is given an option on which route is preferred and, when selected, detailed information regarding a map, step-by-step directions, etc. may be provided. For instance, some users prefer a slower but more scenic route whereas delivery drivers may prefer the fastest route. In general, literally millions of routes are chosen each year using mapping software such as Google Maps™. Logically, it would be statistically improbable or even impossible that two drivers would choose the same route having a common destination (such as a driver's home) at virtually the same moment in time.

Accordingly, the computing device 20 may be configured to determine a statistical probability indicative of a likelihood that two drivers would choose the same route having a common destination, considering elements such as the length of the chosen route, number of turns or connecting roadways along said selected route, etc. In addition, the determination of the computing device 20 regarding the likelihood that two vehicles will select the same route to said selected destination may include algorithms that use machine learning and artificial intelligence that have been trained using thousands of examples that two vehicles traveling to a common destination which use the same route in view of at least all of the conditions stated above. In an embodiment, actual image data comparing images of following vehicles may be cross-referenced with the traffic route conclusion data for purposes of corroboration of an alert. In other words, if the same following vehicle is found at the destination location as well as a predetermined number of prior locations (i.e., such as the final three comparisons) then it is likely that a common destination was chosen as the preferred travel route and a likelihood of that occurrence can be calculated, especially by the artificial intelligence enhanced programming. In such an instance, an alert would be published. A detailed discussion of this methodology will be rehearsed later with reference to the process 100 shown in FIG. 4.

In yet another critical aspect, the system 10 may include a sensor 28 in data communication with the computing device 20 that is operable to detect when the monitoring vehicle 12 is executing a turn. More particularly, the sensor 28 may be an accelerometer, radar, a full inertial measurement unit (IMU), or other motion sensors. Further, the computing device 20 may be configured, such as by executing programming, for actuating the imaging assembly 30 just prior to the detection of a turn and also immediately following the detection of a turn. It is understood that this image data may be collected continuously or at regular intervals and, therefore, may be correlated in real-time to a time immediately prior and immediately after a turn was detected by the sensor 28. Further, the computing device 20 may be configured to compare in real-time the image data taken immediately before and immediately after the turn detection and to determine if the same automobile or automobiles are the same, i.e., the following vehicles are identical.

If so, the computing device 20 may determine that the common following vehicle is a potential stalking vehicle. As described previously, this status may be published on the display 14 and/or speaker 15. Similarly, the computing device 20 may be configured to receive final image data in real time when the predetermined destination has been reached, i.e., the monitoring vehicles home address has been reached. Further, the computing device 20 is configured to compare the final image data to respective image data corresponding to a predetermined number of prior detected turns and, if identical, to generate an alert indicative of a stalking vehicle. In other words, the computing device 20 has received image data corresponding to following vehicles that may have persisted through multiple turns of monitoring vehicles and is still present (i.e., still behind the monitoring vehicle) when the destination has been reached. Clearly, in this scenario, the monitoring vehicle has been followed and the computing device 20 configured to publish this information as an alert on the display 14 and/or speaker 15.

Finally, it is understood that one or all of the tracking methods identified above and with or without the benefit of machine ML/AI algorithms may be executed individually or in combination so as to corroborate any of the other methods such that accuracy in determining or predicting a likelihood that the monitoring vehicle has been followed.

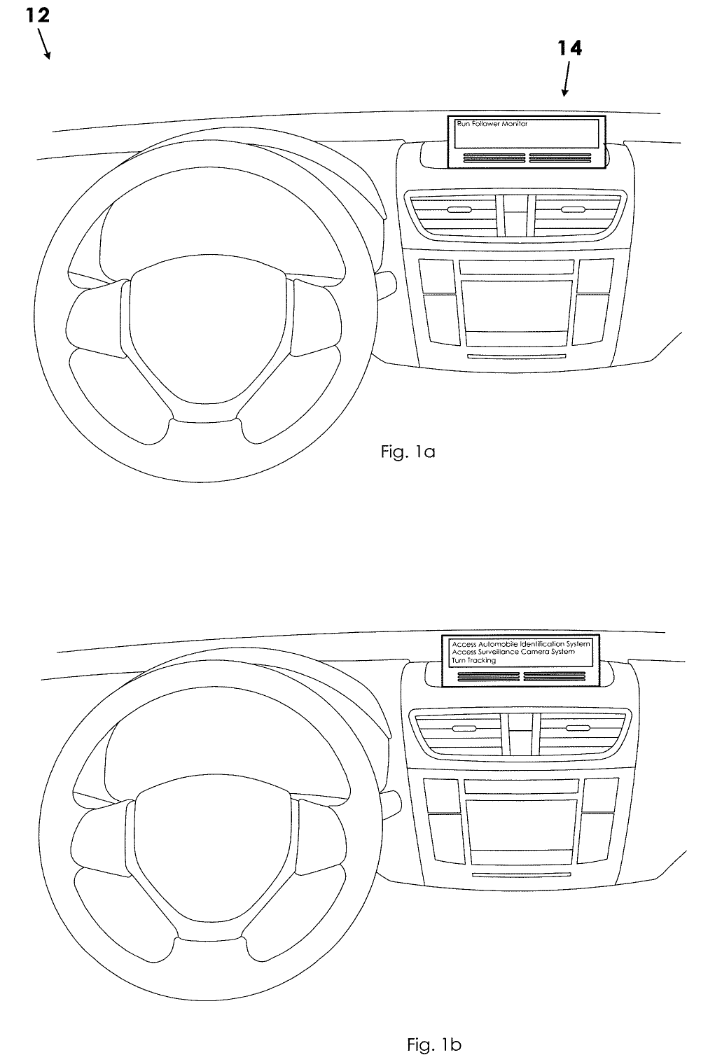

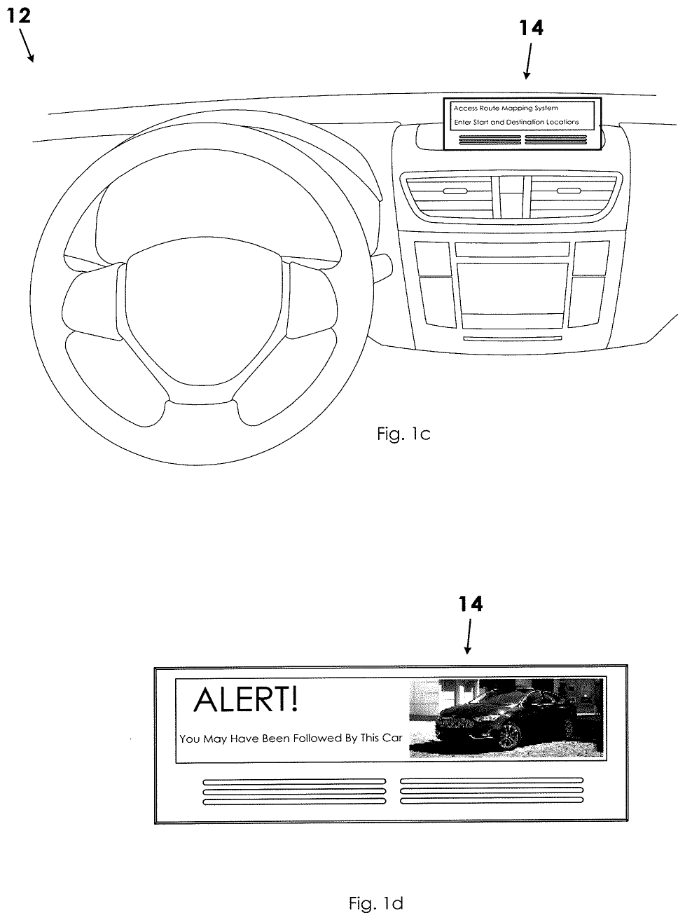

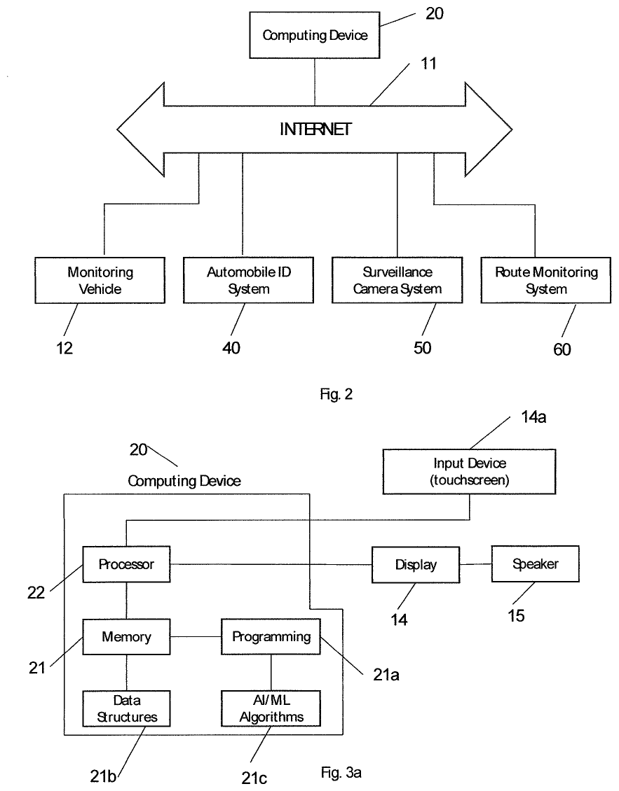

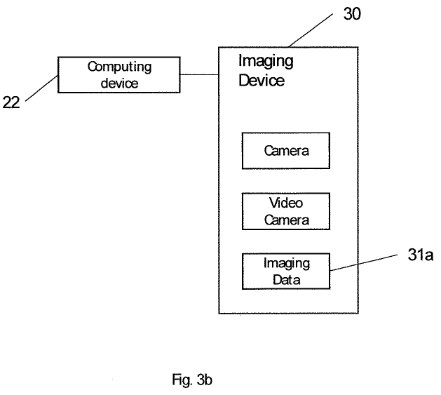

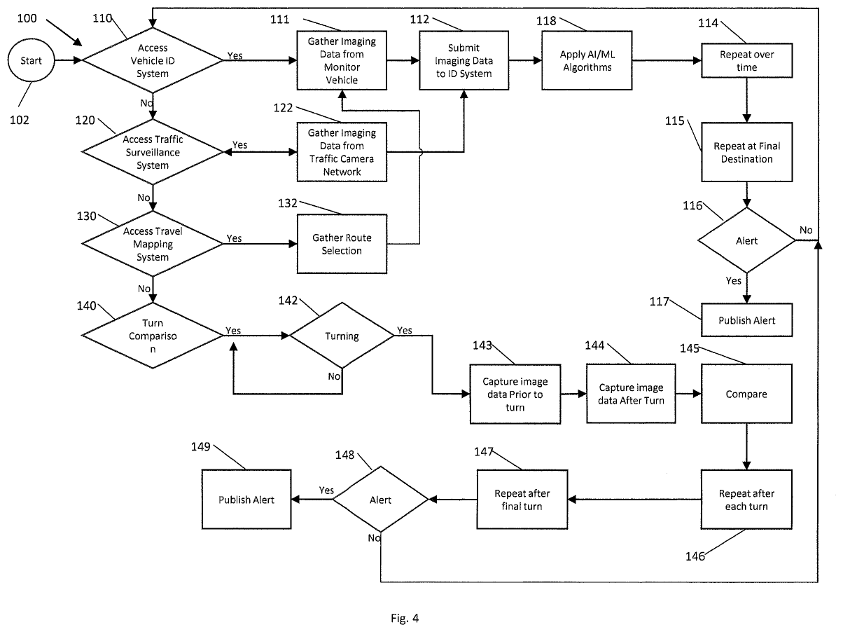

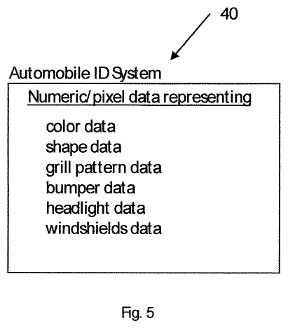

The system 10 described above for determining a likelihood that a monitoring vehicle 12 is being followed or perhaps even stalked for nefarious reasons may be in the form of a mobile app, i.e., a software application installed in a smart-automobile, or other computing device and may include input or output functionality for operation as described above. An equipped smart vehicle 12 is shown in FIGS. 1a through 1d.

A process 100 illustrating the logic of the follower alert system 10 is shown in FIG. 4. The process 100 is preferably implemented as computer software having a plurality of program instructions 21a (aka programming) stored in the non-transitory memory 21 and executable by a processor 22 of the computing device on board a monitoring vehicle 12 that is connected to the Internet 11. According to the process 100 and as indicated in FIG. 4, the process 100 starts at step 102 and, in some implementations, may include a menu of tracking options from which a user may select a current action, this menu being represented by steps 110, 120, 130, and 140. Specifically, the processor 22 determines at step 110 if a user desires to access the vehicle ID system 40 and, if so, the process 100 proceeds to step 111. Otherwise, the process 100 proceeds to step 120. At step 111, the processor 22 may actuate the imaging device 32 collect imaging data such as photographs, video, or the like in real time. The process 100 proceeds to step 112 where the collected imaging data 31a is submitted to the vehicle ID system 40 so as to determine a likely or even certain identification of a follower vehicle. In some embodiments, the process 100 may implement AI/ML algorithms that are configured and trained using thousands of vehicle attributes that may be compared to the imaging data 31a for making a positive identification of the follower vehicle(s). It is understood that this identification data may, in some embodiments, be published to the display 14 or really stored in the data structures 21b for future reference. The process 100 proceeds to step 114 where the steps 111, 112, and 118 may be repeated at predetermined time intervals for later comparisons and determinations if the determined follower vehicles are the same or different. The process 100 may proceed to step 115 if the processor 22 determines that the final destination has been reached, i.e., the drivers residence. The process proceeds to step 116 where the processor 22 determines if an Alert has occurred, i.e., that the same following vehicle(s) has been identified in the imaging data 31a on multiple occasions and, most importantly, at or near the monitoring vehicle's 12 final destination and, if so, the process 100 proceeds to step 117 where an alert message is published on the display 14 or speaker 15 or both. If no alert is found at step 116, the process 100 returns to step 110.

At step 120 (which corresponds to a second tracking option menu), the processor determines if a user has selected the option to access a respective traffic surveillance system 50 and, if so, the processor proceeds to step 122. Otherwise, the menu cycles to step 130 which will be discussed later. At step 122, the processor 22 accesses vehicle imaging data from a respective traffic camera network, e.g., a traffic system associated with a metropolitan area, interstate highway system, or the like, at real times associated when the monitoring vehicle 12 is documented to have passed a respective camera associated with the respective traffic camera network. As described above in greater detail, this option includes obtaining camera or video data showing what vehicle or vehicles are shown immediately following the monitoring vehicle 12 at exact predetermined times. The process 100 then proceeds to step 112 where the collected traffic network data may be submitted to the vehicle ID system 40 in the manner described above at steps 112, 118, et seq. If appropriate, and alert may be published as described at steps 116 and 117 as described above. Then, the process 100 again returns to the menu at step 110.

At step 130, the processor 22 determines if tracking is chosen to be via the Travel Mapping System 60 (also referred to as the Route Monitoring system 60) and, if so, the process proceeds to step 132. Otherwise, the process proceeds to step 140. At step 132, the processor 22 actuates the input mechanism to obtain a route selection from the user (i.e., from the driver of the monitoring vehicle 12). The process 100 then proceeds to execute steps 111 et seq. as described above regarding use of the imaging device 30 to gather imaging data so as to identify the identity of any vehicles that may be following along the chosen route. It is understood that if it is determined that a vehicle has followed the monitoring vehicle 12 so as to cause an alert at step 116, the processor 22 may determine a statistical likelihood that a following vehicle (i.e., the vehicle that was tracked to have followed the monitoring vehicle 12) which is the same route as was selected by the driver of the monitoring vehicle 12. The statistical likelihood (or, the unlikelihood, as the case may be) that the same route would have been chosen by a random vehicle may be considered corroborating evidence that the monitoring vehicle 12 was, in fact, followed.

At step 140, the processor 22 determines whether a user has selected to track following vehicles via the methodology of Turn Comparison and, if so, the process 100 proceeds to step 142. Otherwise, the process 100 may be restarted if desired. At step 142, the processor 22 determines if the monitoring vehicle 12 is executing a turn. As described previously in more detail, a turn may be sensed using an accelerometer or other electronic instrumentation. If a turn is detected, the process 100 proceeds to step 143; otherwise, the process 100 returns to step 142 and continues to monitor until a turn is detected. At steps 143, 144, and 145, imaging data such as photographs or video collected by the imaging device 30 record in real time a record of potentially following vehicles taken just prior to a turn, just after the turn, and then compares the imaging data so as to determine if a following vehicle also executed the same turn as the monitoring vehicle 12. The process 100 proceeds to step 146 wherein the prior steps are repeated just before and just after each turn of the monitoring vehicle 12. The process proceeds to step 147 which indicates that imaging data may be collected at the final turn before a destination is reached. The process proceeds to step 148 wherein the processor 22, executing program code, determines if and Alert condition exists, i.e., that a follower vehicle has, in fact, been detected using any of the means identified above and, if so, the process 100 proceeds to step 149 and the Alert is published to the display 14 or speaker 15. If not, the process returns to step 110 and the tracking process and menu may be executed again.

It is understood that while certain forms of this invention have been illustrated and described, it is not limited thereto except insofar as such limitations are included in the following claims and allowable functional equivalents thereof.

1. A method for identifying in real time if a vehicle having access to the Internet is being stalked, comprising:
repeatedly receiving in real time image data from a rear-facing imaging assembly mounted in the vehicle that is indicative of at least one following vehicle,
said rear-facing imaging assembly including at least one sensor configured to collect identifying data related to said at least one following vehicle;
comparing said collected identifying data with an automobile database accessed via the Internet containing automobile identification characteristics so as to generate identifying data that includes all automobiles that exhibit said collected identifying data; and
comparing said generated identifying data over a plurality of real time intervals so as to determine if said generated identifying data is indicative of a stalking vehicle.

2. The method as in claim 1, wherein said step of comparing said collected image data to said automobile database includes algorithms configured for machine learning (ML) and artificial intelligence (AI) operable to determine said generated identifying data.

3. The method as in claim 2, wherein said ML/AI algorithms are trained using repeated downloads of a plurality of automobile images, each automobile image being represented as a plurality of pixel values associated with a respective automobile.

4. The method as in claim 3, wherein said step of comparing said generated identifying data includes determining if said generated identifying data from a most recent data check matches said generated identifying data from a predetermined consecutive number of prior data checks and, if so, generating potential stalking vehicle data.

5. The method as in claim 4, further comprising determining if said generated potential stalking vehicle data includes a single vehicle and, if so, generating final stalking vehicle data.

6. The method as in claim 1, further comprising:
accessing in real time a traffic surveillance system configured for monitoring traffic flow, said traffic surveillance system configured to identify automobiles that pass a plurality of cameras distributed along streets and roadways;
comparing said collected identifying data with said accessed traffic surveillance system so as to generate matching data that includes all automobiles that match said collected identifying data; and
comparing said matching data over a plurality of real time intervals so as to determine if said matching data is indicative of a stalking vehicle.

7. The method as in claim 6, wherein said step of comparing said collected identifying data with said accessed traffic surveillance system includes executing algorithms configured for machine learning (ML) and artificial intelligence (AI) operable to determine said generated matching data.

8. The method as in claim 7, wherein said ML/AI algorithms are trained using repeated downloads of a plurality of automobile images, each automobile image being represented as a plurality of pixel values associated with a respective automobile.

9. The method as in claim 1, further comprising accessing in real time a travel routing system configured to map common routes for reaching a selected destination, said travel routing system including (1) receiving a route selected by a vehicle driver and (2) determining a likelihood that two vehicles would select a same route to said selected destination.

10. The method as in claim 9, wherein said step of determining said likelihood includes algorithms configured for machine learning (ML) and artificial intelligence (AI) operable to determine said likelihood that two vehicles would select a same route to said selected destination.

11. The method as in claim 10, wherein said ML/AI algorithms are trained using thousands of examples of which mapped route was selected by a user traveling to a predetermined destination.

12. The method as in claim 1, further comprising:
using an accelerometer, detecting when the vehicle is executing a turn;
receiving in real time said imaging data immediately prior to said detected turn;
receiving in real time said imaging data immediately after said detected turn;
comparing in real time said immediately prior imaging data with said immediately after imaging data and generating comparison data; and
if said comparison data is identical, generating potential stalking vehicle data.

13. The method as in claim 12, further comprising repeatedly determining if said comparison data is identical after a predetermined number of turns are detected and, if so, generating final stalking vehicle data.

14. The method as in claim 12, wherein said step of comparing in real time said immediately prior imaging data with said immediately after imaging data and generating comparison data includes algorithms configured for machine learning (ML) and artificial intelligence (AI) operable to determine said generated matching data.

15. The method as in claim 14, further comprising accessing in real time a traffic flow records system having a plurality of records indicative of traffic volume on respective roadways, times, and dates.

16. The method as in claim 15, wherein said ML/AI algorithms are trained using repeated downloads of said plurality of traffic flow records.

17. The method as in claim 1, wherein:
said collected identifying data includes license plate data, camera data, video data, color data, shape data, grill pattern data, bumper data, headlight data, windshield data; and
said automobile identification characteristics include color data, shape data, grill pattern data, bumper data, headlight data, windshield data.

18. A system for identifying in real time if a vehicle having access to the Internet is being stalked, comprising:
a computing device;
a memory device in data communication with said computing device and that includes structures for storing programming and data;
an imaging assembly in data communication with said computing device and mounted in a rear-facing position adjacent a rear windshield of the vehicle,
said imaging assembly including at least one sensor configured to repeatedly collect in real time image data that is indicative of at least one following vehicle;
wherein said computing device, executing said programming, is operable to perform the steps of:
comparing said collected image data with an automobile database accessed via the Internet containing automobile identification characteristics so as to generate identifying data that includes all automobiles that exhibit said collected image data;
comparing said generated identifying data over a consecutive plurality of real time intervals including a final real time interval and, if said generated identifying data includes a common automobile image thereover, publish an alert indicative of a potential stalking vehicle.

19. The system as in claim 18, wherein said computing device, when executing said step of comparing said collected identifying data to said automobile database, is operable to use algorithms configured for machine learning (ML) and artificial intelligence (AI) to determine said generated identifying data, said ML/AI algorithms being trained using repeated downloads of a plurality of automobile images each being represented as a plurality of pixel values associated with a respective automobile.

20. The system as in claim 19, wherein said computing device, executing said programming, is operable to:
access in real-time a traffic surveillance system configured to monitor traffic flow, said traffic surveillance system configured to capture image data of automobiles that pass a plurality of cameras distributed along streets and roadways; and
compare said collected image data with said captured image data so as to generate matching data that identifies and records all automobiles that match said collected identifying data.

21. The system as in claim 20 wherein said computing device, when executing said step of comparing said collected image data to said generated matching data, is operable to use algorithms configured for machine learning (ML) and artificial intelligence (AI) to determine said generated identifying data, said ML/AI algorithms being trained using repeated downloads of a plurality of automobile images each being represented as a plurality of pixel values associated with a respective automobile.

22. The system as in claim 18, wherein said computing device is operable to:
access in real time a travel routing system configured to map multiple routes for reaching a selected destination; and
determine a likelihood that two vehicles would select a same route to said selected destination.

23. The system as in claim 22, wherein:
said computing device, when determining said likelihood, is operable to use algorithms configured for machine learning (ML) and artificial intelligence (AI) configured to determine said likelihood that two vehicles would select a same route to said selected destination; and
said ML/AI algorithms are trained using thousands of examples of two vehicles traveling to a common destination choose the same route to arrive at said common destination.

24. The system as in claim 18, further comprising:
an accelerometer in data communication with said computing device and configured to detect when the vehicle is executing a turn;
wherein said computing device, when executing said programming, is configured to:
receive in real time first respective image data immediately prior to a respective detected turn;
receive in real time second respective image data immediately following said respective detected turn; and
compare in real time said first respective image data with said second respective image data and, if identical, generating potential stalking vehicle data.

25. The system as in claim 24, wherein said computing device is operable to
receive in real time final image data immediately following a final detected turn prior to said vehicle arriving at a predetermined destination; and
comparing in real time said final image data to respective image data corresponding to respective image data corresponding to 3 prior detected turns and, if identical, generate an alert indicative of a stalking vehicle.

26. A method for identifying in real time if a vehicle having access to the Internet is being stalked, comprising:
repeatedly receiving in real time image data from a rear-facing imaging assembly mounted in the vehicle that is indicative of at least one following vehicle,
said rear-facing imaging assembly including at least one sensor configured to collect identifying data related to said at least one following vehicle;
comparing said collected identifying data with an automobile database accessed via the Internet containing automobile identification characteristics so as to generate identifying data that includes all automobiles that exhibit said collected identifying data;
comparing said generated identifying data over a plurality of real time intervals so as to determine if said generated identifying data is indicative of a stalking vehicle;
accessing in real time a traffic surveillance system configured for monitoring traffic flow, said traffic surveillance system configured to identify automobiles that pass a plurality of cameras distributed along streets and roadways;
comparing said collected identifying data with said accessed traffic surveillance system so as to generate matching data that includes all automobiles that match said collected identifying data;
comparing said matching data over a plurality of real time intervals so as to determine if said matching data is indicative of a stalking vehicle;
using an accelerometer, detecting when the vehicle is executing a turn;
receiving in real time said imaging data immediately prior to said detected turn;
receiving in real time said imaging data immediately after said detected turn;
comparing in real time said immediately prior imaging data with said immediately after imaging data and generating comparison data; and
if said comparison data is identical, generating potential stalking vehicle data.
